(19) United States
(12) Patent Application Publication
(10) Pub. No.: US 2022/0066859 A1
(43) Pub. Date: Mar. 3, 2022

(54) METHOD, SYSTEM AND TERMINAL FOR RECORDING ERROR INFORMATION OF BASIC INPUT OUTPUT SYSTEM BASED ON GPNV

(71) Applicants: Inventec (Pudong) Technology Corporation, Shanghai (CN); INVENTEC CORPORATION, Taipei (TW)

(72) Inventors: Xianle Tan, Shanghai (CN); Zhongying QU, Shanghai (CN)

(73) Assignees: Inventec (Pudong) Technology Corporation, Shanghai (CN); INVENTEC CORPORATION, Taipei (TW)

(21) Appl. No.: 17/137,421

(22) Filed: Dec. 30, 2020

(30) Foreign Application Priority Data
Aug. 27, 2020 (CN) 2020108808572

(51) Int. Cl. G06F 11/07; G06F 9/4401; G06F 9/30

(52) U.S. Cl. CPC G06F 11/0787; G06F 11/0772; G06F 9/30101; G06F 9/4403; G06F 11/0775

(57) ABSTRACT

The present disclosure provides a method for recording error information of a basic input output system based on general purpose non volatile (GPNV), which is applied to a basic input output system. The method includes the following: obtaining error information and a type of the error information when an error occurs in a system; recording the error information in a GPNV storage space of the basic input output system; setting a value of a serial general-purpose input/output port according to the type of the error information. The method, system and terminal for recording error information of a basic input output system based on GPNV according to the present disclosure record the BIOS error information through GPNV in the BIOS ROM, ensuring the reliable recording of error information and helping to accurately determine the cause of the error.

### CROSS REFERENCE TO RELATED APPLICATION

This application claims the benefits of priority to Chinese Patent Application No. CN 2020108808572, entitled “Method, System and Terminal for Recording Error Information of Basic Input Output System Based on GPNV”, filed with CNIPA on Aug. 27, 2020, the contents of which are incorporated herein by reference in its entirety.

### TECHNICAL FIELD

The present disclosure relates to the technical field of information recording, and in particular, to a method, system and terminal for recording error information of a basic input output system (BIOS) based on general purpose non volatile (GPNV).

### BACKGROUND

Baseboard management controllers (BMC) can update the firmware of the server, check the machine and perform other operations when the server is not turned on, so as to realize functions such as local and remote diagnosis, console support, configuration management, hardware management and troubleshooting.

The traditional BIOS records reliability, availability and serviceability (RAS) Error information in a BMC SEL Log. Therefore, the user may grab related error information from the BMC SEL Log and find the corresponding device. However, the above method has the following disadvantages:

(1) the recording of RAS Error information by SEL Log is too dependent on BMC; when BMC fails or the system does not support BMC, the error information sent by BIOS cannot be recorded;

(2) the failure of Error information recording will lead to failure of users to timely capture and locate the relevant components where the Error occurs and causes of Error, which will bring certain risks to users in troubleshooting.

### SUMMARY

The present disclosure provides a method, system and terminal for recording error information of a basic input output system based on general purpose non volatile (GPNV). In the present disclosure, the BIOS error information is recorded through GPNV in the BIOS read-only memory (ROM), which ensures the reliable recording of error information and helps to accurately determine the cause of the error.

The first aspect of the present disclosure provides a method for recording error information of a basic input output system based on general purpose non volatile (GPNV), which is applied to a basic input output system. The method includes the following: obtaining error information and a type of the error information when an error occurs in a system; recording the error information in a GPNV storage space of the basic input output system; setting a value of a serial general-purpose input/output port according to the type of the error information.

In an embodiment of the present disclosure, when an error occurs in the system, a corresponding error register is set, and the type of error information is obtained according to the setting value of the error register.

In an embodiment of the present disclosure, a GPNV Handle is called based on a basic input output system RAS Error Handle, and the error information is recorded in the GPNV storage space based on the GPNV Handle.

In an embodiment of the present disclosure, the GPNV Handle is called based on the basic input output system RAS Error Handle, the value of the serial general-purpose input/output port is set based on the GPNV Handle, and the value of the serial general-purpose input/output port corresponds to the type of error information one-to-one.

Correspondingly, the second aspect of the present disclosure provides a system for recording error information of a basic input output system based on GPNV, which is applied to a basic input output system. The system includes an obtaining module, a recording module and a setting module;

the obtaining module obtains error information and a type of the error information when an error occurs in the system;

the recording module records the error information in a GPNV storage space of the basic input output system;

the setting module sets a value of a serial general-purpose input/output port according to the type of the error information.

In an embodiment of the present disclosure, when an error occurs in the system, a corresponding error register is set, and the type of error information is obtained by the obtaining module according to the setting value of the error register.

In an embodiment of the present disclosure, the recording module calls a GPNV Handle based on a basic input output system RAS Error Handle, and the error information is recorded in the GPNV storage space based on the GPNV Handle.

In an embodiment of the present disclosure, the setting module calls the GPNV Handle based on the basic input output system RAS Error Handle, the value of the serial general-purpose input/output port is set based on the GPNV Handle, and the value of the serial general-purpose input/output port corresponds to the type of error information one-to-one.

The third aspect of the present disclosure provides a terminal, including: a processor and a memory;

the memory stores a computer program;

the processor executes the computer program stored in the memory, causes the terminal to execute the method for recording error information of a basic input output system based on GPNV provided in the first aspect of the present disclosure.

As described above, the method, system and terminal for recording error information of a basic input output system based on GPNV of the present disclosure have the following beneficial effects:

(1) the recording of BIOS error information is realized through GPNV in BIOS ROM without relying on BMC;

(2) GPNV is a non-volatile storage space on the BIOS ROM, therefore, the error information would not be lost after the system is powered off or restarted, ensuring the safety and reliability of error information storage;

(3) the cause of the error and the equipment where the error occurs can be recorded in real time based on serial general-purpose input/output port (SGPIO), which is helpful to realize the accurate investigation of the error.

### BRIEF DESCRIPTION OF THE DRAWINGS

FIG. 1 shows a flow chart of a method for recording error information of a basic input output system based on GPNV according to an embodiment of the present disclosure.

FIG. 2 shows a schematic diagram of a system for recording error information of a basic input output system based on GPNV according to an embodiment of the present disclosure.

FIG. 3 shows a schematic diagram of a terminal according to an embodiment of the present disclosure.

### DESCRIPTION OF REFERENCE NUMERALS

21 Obtaining module
22 Recording module
23 Setting module
31 Processor
32 Memory

### DETAILED DESCRIPTION OF THE PREFERRED EMBODIMENTS

The embodiments of the present disclosure will be described below. Those skilled in the art can easily understand other advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complex.

The method, system and terminal for recording error information of a basic input output system based on GPNV of the present disclosure record the BIOS error information through GPNV in the BIOS ROM, which not only ensures the reliable recording of error information, but also helps to accurately determine the cause of the error, without occupying additional resource, and is therefore extremely practical.

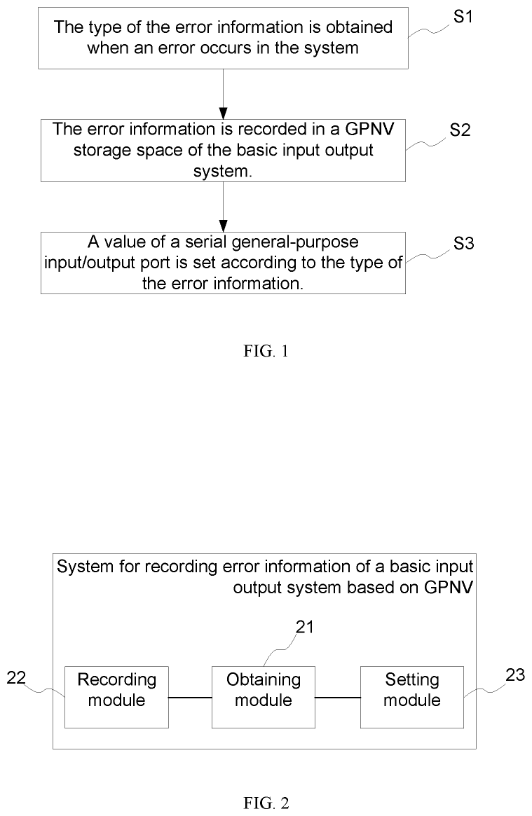

As shown in FIG. 1, in an embodiment, the method for recording error information of a basic input output system based on GPNV according to the present disclosure is applied to a BIOS. The method includes the following:

S1, error information and a type of the error information are obtained when an error occurs in the system;

Specifically, when an error occurs in the system, the error information is generated, the corresponding error register is set, and a system management interruption (SMI) Handle is triggered. SMI is triggered by the hardware and handled by the BIOS. BIOS RAS Error Handle classifies error information according to the setting value of the error register, that is to say, different setting values of the error register correspond to different types of error information. Therefore, the type of error information may be obtained according to the setting value of the error register.

S2, the error information is recorded in a GPNV storage space of the basic input output system.

Specifically, in an embodiment of the present disclosure, a GPNV Handle is called based on a BIOA RAS Error Handle, and the error information is recorded in the GPNV storage space based on the GPNV Handle. GPNV is a part of BIOS ROM and generally occupies 8-16 KB of space. GPNV may store information such as ESCD, SMBios, System Event log without losing the information after a power failure.

S3, a value of a serial general-purpose input/output port is set according to the type of the error information.

Specifically, the GPNV Handle is called based on the BIOS RAS Error Handle, the value of the serial general-purpose input/output port (SGPIO) is set based on the GPNV Handle, and the value of the serial general-purpose input/output port corresponds to the type of error information one-to-one. Therefore, the type of error information may be obtained according to the value of the SGPIO.

At this point, the user may obtain the error information and error type by reading the error information in GPNV and the value of SGPIO, which helps to analyze the cause of the error and the equipment where the error occurs.

As shown in FIG. 2, in an embodiment, the system for recording error information of a basic input output system based on GPNV according to the present disclosure is applied to a basic input output system. The system includes an obtaining module 21, a recording module 22 and a setting module 23.

The obtaining module 21 obtains error information and a type of the error information when an error occurs in the system.

Specifically, when an error occurs in the system, the error information is generated, the corresponding error register is set, and a system management interruption (SMI) Handle is triggered. SMI is triggered by the hardware and handled by the BIOS. BIOS RAS Error Handle classifies error information according to the setting value of the error register, that is to say, different setting values of the error register correspond to different types of error information. Therefore, the type of error information may be obtained according to the setting value of the error register.

The recording module 22 is connected with the obtaining module 21, to record the error information in a GPNV storage space of the basic input output system.

Specifically, in an embodiment of the present disclosure, a GPNV Handle is called based on a BIOA RAS Error Handle, and the error information is recorded in the GPNV storage space based on the GPNV Handle. GPNV is a part of BIOS ROM and generally occupies 8-16 KB of space. GPNV may store information such as ESCD, SMBios, System Event log without losing the information after a power failure.

The setting module 23 is connected with the obtaining module 21, to set a value of a serial general-purpose input/output port according to the type of the error information.

Specifically, the GPNV Handle is called based on the BIOS RAS Error Handle, the value of the serial general-purpose input/output port (SGPIO) is set based on the GPNV Handle, and the value of the serial general-purpose input/output port corresponds to the type of error information one-to-one. Therefore, the type of error information may be obtained according to the value of the SGPIO.

At this point, the user may obtain the error information and error type by reading the error information in GPNV and the value of SGPIO, which helps to analyze the cause of the error and the equipment where the error occurs.

It should be noted that the division of each module of the above apparatus is only a division of logical functions. In actual implementation, the modules may be integrated into one physical entity in whole or in part, or may be physically separated. These modules may all be implemented in the form of software called by processing component. These modules may also be implemented entirely in hardware. It is also possible that some modules are implemented in the form of software called by processing component, and some modules are implemented in the form of hardware. For example, the x module may be a separate processing element, or may be integrated in a chip of the above-mentioned apparatus, or may be stored in the memory of the above apparatus in the form of program code. The function of the above x module is called and executed by one of the processing elements of the above apparatus. The implementation of other modules is similar. In addition, all or part of these modules may be integrated or implemented independently. The processing elements described herein may be an integrated circuit with signal processing capabilities. In the implementation process, each operation of the above method or each of the above modules may be completed by an integrated logic circuit of hardware in the processor element or an instruction in a form of software.

For example, the above modules may be one or more integrated circuits configured to implement the above method, such as one or more application specific integrated circuits (ASIC), or one or more digital signal processors (DSP), or one or more field programmable gate arrays (FPGA). As another example, when one of the above modules is implemented in the form of calling program codes of a processing element, the processing element may be a general processor, such as a central processing unit (CPU) or other processors that may call program codes. As another example, these modules may be integrated and implemented in the form of a system-on-a-chip (SOC).

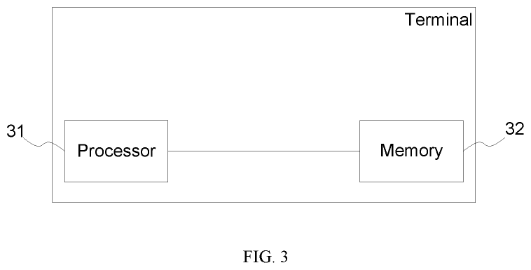

As shown in FIG. 3, in an embodiment, the terminal of the present disclosure includes: a processor 31 and a memory 32.

The memory 32 stores a computer program.

The memory 32 includes various medium that may store program codes, such as a ROM, a RAM, a magnetic disk, a USB flash disk, a memory card, or an optical disk.

The processor 31 is in communication with the memory 32. The processor 31 executes the computer program stored in the memory 32, causes the terminal to execute the method for recording error information of a basic input output system based on GPNV provided in the first aspect of the present disclosure.

Preferably, the processor 31 may be a general processor, such as a central processing unit (CPU), a network processor (NP), and the like. The processor 31 may also be a digital signal processor (DSP), an application specific integrated circuit (ASIC), a field-programmable gate array (FPGA), or other programmable logic devices, discrete gate or transistor logic devices, or discrete hardware components.

In summary, the method, system and terminal for recording error information of a basic input output system based on GPNV according to the present disclosure record the BIOS error information through GPNV on the BIOS ROM, without relying on BMC; GPNV is a non-volatile storage space on the BIOS ROM, therefore, the error information would not be lost after the system is powered off or restarted, ensuring the safety and reliability of error information storage; the cause of the error and the equipment where the error occurs can be recorded in real time based on SGPIO, which is helpful to realize the accurate investigation of the error. Therefore, the present disclosure effectively overcomes various shortcomings and has high industrial utilization value.

The above-described embodiments are merely illustrative of the principles of the disclosure and its effects, and are not intended to limit the disclosure. Modifications or variations of the above-described embodiments may be made by those skilled in the art without departing from the spirit and scope of the disclosure. Therefore, all equivalent modifications or changes made by those who have common knowledge in the art without departing from the spirit and technical concept disclosed by the present disclosure shall be still covered by the claims of the present disclosure.

We claim:

1. A method for recording error information of a basic input output system based on general purpose non volatile (GPNV), which is applied to a basic input output system, wherein the method comprises:
obtaining error information and a type of the error information when an error occurs in a system;
recording the error information in a GPNV storage space of the basic input output system;
setting a value of a serial general-purpose input/output port according to the type of the error information.

2. The method for recording error information of a basic input output system based on GPNV according to claim 1, when the error occurs in the system, setting a corresponding error register, and obtaining the type of the error information according to a setting value of the error register.

3. The method for recording error information of a basic input output system based on GPNV according to claim 1, wherein a GPNV Handle is called based on a basic input output system RAS Error Handle, and the error information is recorded in the GPNV storage space based on the GPNV Handle.

4. The method for recording error information of a basic input output system based on GPNV according to claim 1, wherein a GPNV Handle is called based on a basic input output system RAS Error Handle, and the value of the serial general-purpose input/output port is set based on the GPNV Handle, wherein the value of the serial general-purpose input/output port corresponds to the type of the error information one-to-one.

5. A system for recording error information of a basic input output system based on GPNV, which is applied to a basic input output system, wherein the system comprises an obtaining module, a recording module and a setting module;
the obtaining module obtains error information and a type of the error information when an error occurs in a system;
the recording module records the error information in a GPNV storage space of the basic input output system;
the setting module sets a value of a serial general-purpose input/output port according to the type of the error information.

6. The system for recording error information of a basic input output system based on GPNV according to claim 5, when the error occurs in the system, a corresponding error register is set, and the type of the error information is obtained by the obtaining module according to a setting value of the error register.

7. The system for recording error information of a basic input output system based on GPNV according to claim 5, wherein the recording module calls a GPNV Handle based on a basic input output system RAS Error Handle, and the error information is recorded in the GPNV storage space based on the GPNV Handle.

8. The system for recording error information of a basic input output system based on GPNV according to claim 5, wherein the setting module calls a GPNV Handle based on a basic input output system RAS Error Handle, the value of the serial general-purpose input/output port is set based on the GPNV Handle, and the value of the serial general-purpose input/output port corresponds to the type of the error information one-to-one.

9. A terminal, comprising a processor and a memory;
the memory stores a computer program;
and the processor executes the computer program stored in the memory, causes the terminal to execute the method for recording error information of a basic input output system based on GPNV according to claim 1.
